(19) United States
(12) Patent Application Publication
(10) Pub. No.: US 2006/0172034 A1
(43) Pub. Date: Aug. 3, 2006

(54) Guiding system for an externally actuating of a closing unit

(76) Inventors: Erwin Laar, Holzkirchen (DE); Manfred Holzner, Grobenzell (DE)

Correspondence Address: HENRY M FEIEREISEN, LLC, 350 FIFTH AVENUE, SUITE 4714, NEW YORK, NY, 10118, US

(21) Appl. No.: 10/547,513

(22) PCT Filed: Dec. 3, 2003
(86) PCT No.: PCT/EP03/13607

§ 371 Date: Aug. 29, 2005

(30) Foreign Application Priority Data
Feb. 28, 2003 (DE) 103 09 974.3

(51) Int. Cl. B29C 33/20

(52) U.S. Cl. 425/451.4

(57) ABSTRACT

The invention relates to a guide system for an externally operated part of a closing unit, in particular for a mold holder of a closing unit, wherein the closing unit (12) executes during operation a movement in a predefined direction (D), and the externally operated part (14) is moveable during the course of movement between at least two positions. The externally operated part (14) includes a guide element embodied in the form of a cam roller (24) which rolls on a support structure (26-40) for attaining at least one of the positions during the movement of the closing unit (12). In order to avoid excessive wear and ease a maintenance service, at least one section (30) of the support structure (26-40) is provided with at least one freely movable support roller (40) whose respective axis is substantially tangential in relation to the movement direction (D) of the closing unit (12) so that the cam roller (24) of the externally operated part (14) rolls substantially without sliding friction on the support roller (40).

The invention relates to a guide system for an externally operated part of a closing unit, in particular for tool holders of a closing unit, according to the preamble of claim 1.

In the following, reference is made to a closing unit for a plastics processing machine with at least one tool holder in which a tool, also called mold or half-mold, is held. It should be expressly noted, however, that the present invention is equally applicable for other externally operated parts of closing units.

Closing units of plastics processing machines, such as polyurethane installations, normally have two mold holders which are movable for closing and opening of the closing unit and thus at the same time of the accommodated mold. In this context, reference is made to German patent publication DE 101 52 392 which describes a closing unit for a plastics machine. The illustrated closing unit includes a lower mold holder and an upper mold holder which are each swingable about a common axis. During operation of the entire closing unit, the lower mold holder is moved back and forth between two positions, namely a lower position in which the mold elements are placed into a mold or mold parts can be removed, and an upper position in which the starting material is introduced and the closing unit overall is closed to allow reaction of the foam components.

In DE 101 52 392, the closing units themselves are fixedly disposed at one location, only the mold holders are swingably mounted.

It is, however, known, to arrange for example several closing units upon a rotary platform, with the individual closing units successively undergoing the same operating steps during operation of the rotary platform. For example, a starting material may be introduced, when the closing unit is open. At the same time, the reaction takes place in other closing units. In still another closing unit, a finished molded part may be withdrawn at the same time. The use of such devices—likewise as in DE 101 52 392—requires operation, especially pivoting, of the various parts of the closing unit in a predefined manner.

A method for external operation of a mold holder is know per se, using a guiding slot mechanism, whereby a cam roller is arranged upon an externally operated (i.e. from outside the closing unit) part of a closing unit, for example the lower mold holder, for running on a support structure. Conventionally, the support structure is realized by a rail arrangement whose respective height is so constructed via for example a rotation section of the rotary platform that the pivoting position of the cam roller mounted to the part being externally actuated can be adjusted as the cam roller is supported and rolls off. Concretely, the support structure includes, for example, two ramp portions, namely an upwardly directed ramp and a downwardly directed ramp as well as a rail part at constant height disposed in-between. When the cam roller of the part to be externally operated reaches the upwardly directed ramp, this part of the closing unit is, for example, elevated to an upper position as the cam roller rolls on this support section, and remains there for as long as the cam roller rolls on the further rail section at constant height. When the cam roller then rolls finally along the downwardly directed ramp, the part to be externally operated is moved by its own weight downwards and ultimately brought to a standstill in a predefined position by a stop.

The use of such rigid rails for a support structure suffers, however, the drawback of experiencing substantial wear as a result of friction when imprecise adjustment causes a relative movement between cam roller and rail. Moreover, the precise manufacture of such rail system has proven expensive and complicated. Complex is also the replacement of certain rail portions.

It is an object of the present invention to minimize in a guide system of the afore-stated type the wear at least on some partial sections and to ensure easy replacement.

This object is attained by the features set forth in claim 1.

An essential feature of the invention is thus the provision of at least one section of the support structure with a freely moveable support roller having an axis in substantial parallel or tangential relationship to the movement direction of the closing unit or cam roller on the closing unit. As a consequence of this constructive design, there is no sliding friction, even when the point of contact of the cam roller on the support structure shifts because the support roller is turned in the respective manner during such shift of the point of contact and the cam roller rolls thereby in its axial direction on the support roller. In the absence of a sliding friction, wear on the inventive section of the support structure can be significantly reduced. Thus, the mold holder can be operated externally without friction-based wear, even in the presence of misalignments and radial deviations of the support structure.

Furthermore, the cam roller of the part to be externally operated is acted upon not only in one point or line. Rather, the line of contact travels across a significant portion of the roller width. Also the support rollers of the support structure can travel about the entire circumference according to a statistical distribution. In contrast thereto, a rigid pipe would always have only one line of contact with the cam roller.

Overall, minimal wear can be ensured without additional adjustments by an automatic adjustment of the rolling behavior, compensation of manufacturing and assembly tolerances, and simplified exchange of partial sections of the support structure.

Of course, the section of the support structure, having at least one freely moveable support roller, may be provided with several support rollers as well. In this case, the support rollers should overlap in their axial extension such as to establish a smooth transfer of the cam roller from one support roller to the next support roller.

According to a preferred embodiment of the invention, upwardly or downwardly directed ramps are formed by the sections which include the freely moveable support rollers. It is these parts of the subassembly that are subject to stress in particular, on one hand. On the other hand, precise alignment and construction of these sections require particular care when using a rail. When using a support roller in connection with a ramp, its axis must extend at a certain angle upwards or downwards in relation to the movement direction so that lifting or lowering of the mold holder becomes possible.

It is not necessarily required to provide the entire support structure by means of support rollers. It is also possible, to realize sections in the form of the conventional guide rail. In particular, the use of a guide rail is appropriate at such locations that are easy to adjust and less exposed to stress and which encounter anyway little friction-based wear.

Also, there is no need to continuously define the position of the part to be externally operated through interaction of the cam roller with the support structure. It is, for example, possible, to spontaneously realize a lower position of the part to be externally operated by providing a further frame element of the closing element with a stop for this part.

According to a particularly preferred embodiment, at least one closing unit is arranged on a turntable. Of course, several closing units (e.g. 12 units) may be provided on the turntable at same radial distances from the center of the turntable. The turntable can be operated during operation of the closing unit so that the individual closing units move about a circular line. The roller moves on a toroidal surface line. When using a turntable, the support structure should be arranged about a pitch circle and associated to the pivot point. It may include preferably an upwardly directed ramp which has been realized by means of the support rollers, a section with a guide rail, and a downwardly directed ramp which has also been realized with support rollers.

Of course, the invention may also be used in oval installations exhibiting a circular or linear movement of the closing units.

An embodiment of the present invention will now de described in greater detail by way of example with reference to the attached drawings, in which:

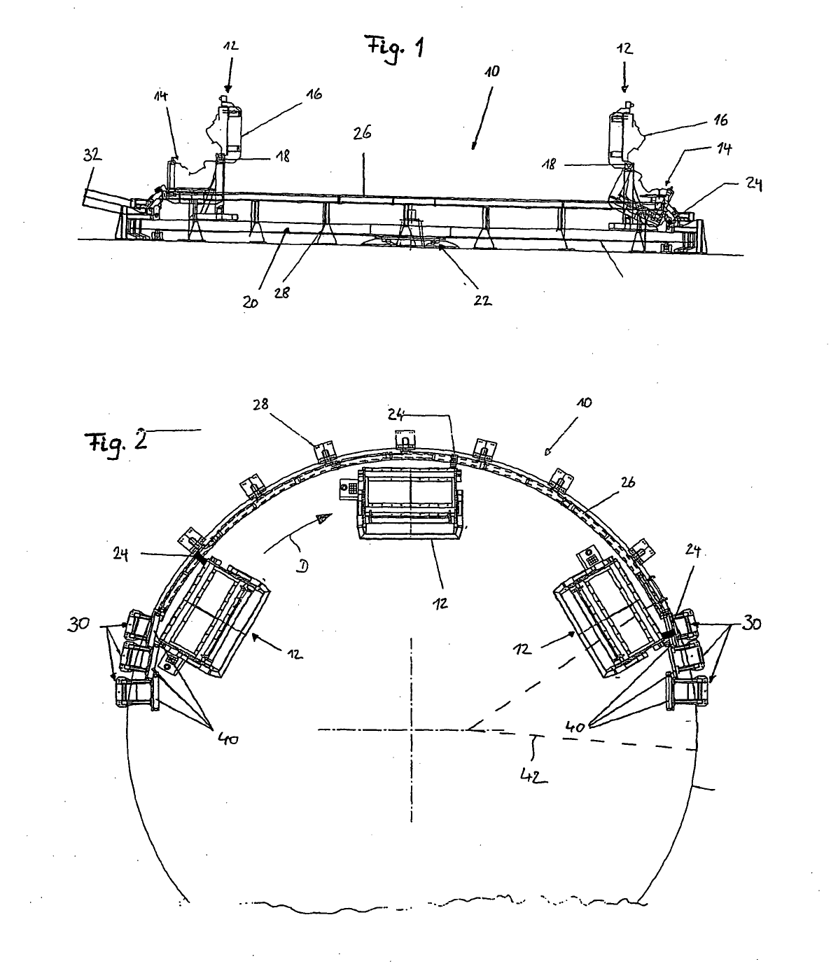

FIG. 1 shows a greatly schematic side view of a carousel-type installation with several closing units and a guide system according to the present invention,

FIG. 2 shows a plan view of a carousel-type system according to FIG. 1, with the carousel shown only partially,

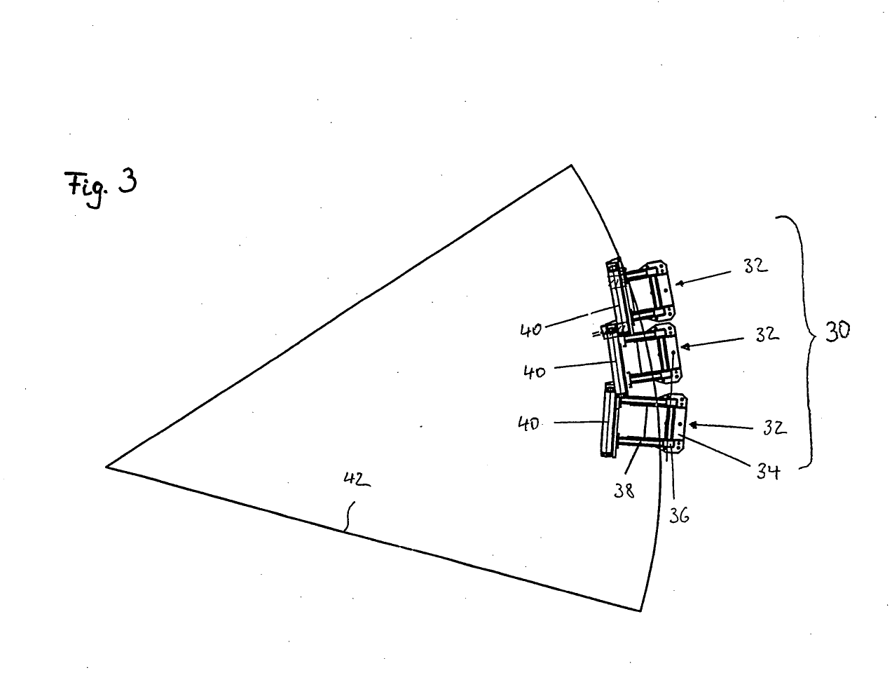

FIG. 3 shows a circular segment of FIG. 2, depicting a detailed view of a ramp of the guide system according to the invention,

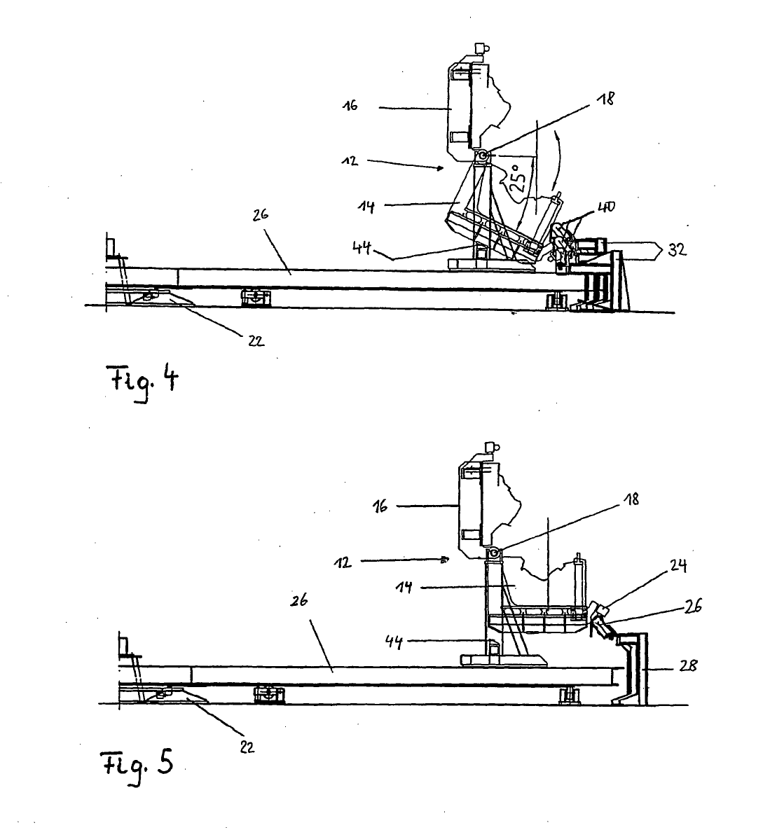

FIG. 4 shows a portion of the schematic illustration according to FIG. 1 with the ramp of the guide system according to the invention, and

FIG. 5 shows a portion of a further portion of the carousel of FIG. 1.

The present invention will now be described in greater detail with reference to a carousel-type system for PUR installations (polyurethane installations). However, the invention is not limited to this system.

Several closing units 12 of a PUR installation (2 in FIG. 1, 3 in FIG. 2), not shown in more detail, are securely disposed on a turntable 20 at substantially same radial distance to its center and in angular offset relationship. Each closing unit 12 includes a lower mold holder 14 and an upper mold holder 12 which can both pivot upwardly and downwardly about a common joint axis 18. The closing unit can be closed or opened in its entirety by pivoting the lower and upper mold holders 14, 18. As a consequence, the mold holders can be brought into a position that allows introduction of mold elements in ergonomically beneficial manner or removal of molded products from the mold.

The present invention is concerned only with pivoting of the lower mold holder 14. The pivot mechanism for the upper mold holder 12 will not be described in more detail.

In relation to the dimension of the turntable, the lower mold holder 14 includes a radially outwardly projecting arm having an outer end for arrangement of a cam roller 24. The rotation axis of the cam roller 24 substantially coincides with the radial direction of the turntable; however it may also slightly deviate therefrom as a result of the off-center arrangement.

Each cam roller 24 of a closing unit runs upon a support structure which in the present case is comprised of two ramps 30 as well as a guide rail 26. Both ramps 30 as well as the guide rail 26 extend substantially in the form of a circular segment over a portion of the outer circumference of the turntable 20. The guide rail 26 is held by a plurality of stanchions 28 of which only one is respectively labeled with a reference character in FIGS. 1 and 2. The guide rail 26 extends—as shown in FIG. 1—at constant height.

Provided on each of both ends of the guide rail 26 are two ramps 30, each of which having three stands 32 as shown in greater detail in FIG. 3 by the segment 42 cut from FIG. 2. Each stand 32 includes a base 34 which is mounted onto the ground radially outside the turntable, a support leg 36 arranged on the base, an arm 38 disposed on the upper end of the support leg 36, as well as a support roller 40 disposed on the inner end of the arm 38. The support roller 40 is held on both sides in bearings of the arm 38 and freely rotatable about a rotation axis. The rotation axis extends here substantially tangential to the rotation direction D (see arrow D in FIG. 1) of the turntable 20 and slopes upwardly or downwardly in relation to the rotation movement.

The mode of operation of the turntable is as follows.

The turntable is rotated in direction of arrow D (FIG. 2) together with the attached closing units 12. When the cam roller 24 of a closing unit reaches the ramp 30, illustrated in FIG. 2 on the left-hand side, it successively runs on the three support rollers 40 upwards. To ensure a smooth rolling operation, the ends of the support rollers 40 overlap in axial direction so that the cam roller 24, when reaching one end of a support roller, bears at the same time on a second support roller. Once the cam roller 24 of a lower mold holder 14 has passed the support rollers and has been elevated—together with the mold holder 14- to an upper level, it travels on the rail 26 to the end thereof. Passage of the ramp 30 causes the lower mold holder to be elevated from a lower position to an upper position. The lower mold holder 14 remains in the upper position so long as the cam roller 24 travels on the rail 26. When the cam roller 24 travels then in opposite manner to the first ramp on the second ramp shown in FIG. 2 on the right-hand side, the lower mold holder 14 is moved downwards again. In a same manner as in the first ramp, the cam roller 24 runs successively on three support rollers 40 in overlapping configuration.

The lower position of the mold holder 14 is defined by the frame of the mold holder striking against a stop 44. In this position, the cam roller 24 has no function.

FIG. 4 depicts again the ramp as formed by the three support rollers 40. The cam roller 24 is hereby not clearly shown. It travels, however, always on one of the support rollers 40.

FIG. 5 illustrates the manner by which the cam roller 24 travels on the rail 26 and maintains the lower mold holder in the upper position.

The use of the support rollers 40 in the ramp zone prevents a sliding movement of the cam rollers 24 on a rail and thus excessive wear. Rather, the support rollers 40 rotate in one or the other direction (substantially in axial direction of the cam roller 24), depending on whether the contact point travels inwards or outwards to the cam roller 24.

In view of the axial change of the contact point upon the cam roller 24, the latter is acted upon not only at one spot. Rather, the line of contact travels on the roller width, for example upon 70% of the roller width, thereby also contributing to a minimization of wear.

Thus, there is not necessarily a need to precisely align the individual stands 32 having the support rollers 40 on its upper, inner end in order to minimize wear as a consequence of sliding friction. In view of the free rotatability of the support rollers, the sliding friction can be easily kept small, even when the support rollers are not in precise alignment. Further, the use of several stands with support rollers is conducive for a simple and cost-efficient replacement. Only the one support roller has to be replaced which exhibits certain wear after a long service life.

Of course, remaining portions of the support structure may also be realized with rollers. However, the guide rail can be manufactured in the area of constant height with more precise tolerances and with a wider running surface so that the use of support rollers is not necessarily required here.

In summary, the invention allows prevention of excessive wear, easier adjustment, compensation of manufacturing and assembly tolerances, as well as easier replacement of partial sections. In addition, the invention also permits an arrangement of the cam roller axes in such a way that the touching tangent is prevented from extending through the pivot point of the closing unit.

### List of Reference Characters

10 Carousel-type system with closing units
12 closing unit
14 lower mold holder
16 upper mold holder
18 joint axis
20 turntable
22 central support with bearing
24 cam roller of the lower mold holder
26 rail
28 rail support
30 ramp
32 stand
34 base
36 support leg
38 arm
40 support roller
42 segment
44 stop
D rotation direction

1. A guide system for an externally operated part of a closing unit, comprising:
a support structure; and
a closing unit moveable in a predefined movement direction during operation and having an externally operated part moveable between at least two positions, said
part including a guide element in the form of a cam roller which travels on the support structure for reaching at least one of the positions, as the closing unit moves,
wherein the support structure has at least one section which includes at least one freely moveable support roller rotatable about a rotation axis which is arranged in substantial parallel or tangential relationship to the movement direction of the closing unit so that the cam roller of the externally operated part rolls on the support roller substantially without sliding friction.

2. The guide system according to claim 1, wherein the at least one section of the support structure has two or more of said support roller, said support rollers overlapping in their axial extension such as to establish a smooth transfer of the cam roller from one support roller to the next support roller.

3. The guide system according to claim 1, wherein the at least one section forms an upwardly directed or downwardly directed ramp.

4. The guide system according to claim 1, wherein the support structure includes a guide rail in overlapping relationship to the section so as to establish a smooth transfer for the cam roller when moving between the section and the guide rail.

5. The guide system according to claim 1, further comprising a stop for defining a stop position for the externally operated part.

6. The guide system according to claim 1, further comprising a turntable for arrangement of the closing unit, said turntable being constructed to move the closing unit in a circle during operation of the turntable.

7. The guide system according to claim 6, wherein the section forms a first ramp for upwardly moving the externally operated part, said support structure further including a further section to define a second ramp for downwardly moving the externally operated part, and a guide rail extending between the first and second ramps, wherein the first and second ramps have support rollers or are formed of support rollers.

8. The guide system according to claim 2, wherein one of the sections forms an upwardly directed ramp and another one of the sections forms a downwardly directed ramp.
